(19) United States
(12) Patent Application Publication
(10) Pub. No.: US 2017/0028969 A1
(43) Pub. Date: Feb. 2, 2017

(54) DEVICE FOR COVERING HEAD LAMP WASHER OF VEHICLE

(71) Applicants: Hyundai Motor Company, Seoul (KR); Hyundai Mobis Co., Ltd., Seoul (KR); Kia Motors Corporation, Seoul (KR)

(72) Inventors: Jae Young Kang, Anyang (KR); Young Ik Cho, Hwaseong (KR); Seung Hyeob Lee, Ansan (KR); Moon Seob Hwang, Yongin (KR)

(21) Appl. No.: 14/963,742

(22) Filed: Dec. 9, 2015

(30) Foreign Application Priority Data
Jul. 28, 2015 (KR) 10-2015-0106561

(51) Int. Cl. B60S 1/60; B29C 65/08; B08B 3/02

(52) U.S. Cl. CPC B60S 1/60; B08B 3/02; B29C 65/08; B29L 2031/747

(57) ABSTRACT

A device for covering a head lamp washer of a vehicle is mounted on a bumper cover so as to be opened and closed, and thus covers the head lamp washer. The device, which includes a protruding open-type washer cover connected to a head unit of a telescope, may move forward so as to be opened when the head lamp washer moves forward, absorb assembly tolerance, and accurately match an opening of the bumper cover.

### CROSS-REFERENCE TO RELATED APPLICATION

This application claims under 35 U.S.C. §119(a) the benefit of Korean Patent Application No. 10-2015-0106561 filed on Jul. 28, 2015, the entire contents of which are incorporated herein by reference.

### BACKGROUND

(a) Technical Field

The present invention relates to a device for covering a head lamp washer of a vehicle which is mounted on a bumper cover so as to be opened and closed, and thus covers the head lamp washer.

(b) Description of the Related Art

In general, a head lamp washer is a device which jets a high-pressure washer liquid onto the surface of a head lamp to remove dust from the head lamp, and is mounted within a bumper cover so as to be movable forward and backward.

The head lamp washer includes a telescope which is movable forward and backward and a washer nozzle formed at a head unit of the telescope to jet a washer liquid at a high pressure. The head lamp washer is located within the bumper cover by backward movement of the telescope if jetting of the washer liquid is not required, and moves to the outside of the bumper cover by forward movement of the telescope if jetting of the washer liquid is required.

Further, in order to move the head lamp washer forward and backward, an opening serving as a forward and backward movement passage of the head lamp washer is formed on the bumper cover and a separate washer cover is mounted at the opening so as to be opened and closed.

Here, the washer cover is configured so as to cover the opening of the bumper cover at normal times in consideration of aesthetics of the external appearance of the washer cover and then to be opened when the head lamp washer moves forward and backward.

In more detail, washer covers are classified into a protruding open type washer cover which is installed at the front end of a head lamp washer to cover an opening of a bumper cover at normal times and then to move forward to be opened when the head lamp washer moves forward, and a rotatable open type which is installed at an opening of a bumper cover so as to be angularly rotatable and is angularly rotated to be opened when the head lamp washer moves forward and backward.

However, conventional washer covers have problems as follows.

The above-described protruding open type washer cover is mounted at a head unit of a telescope by a fixing method and thus causes difficulty in accurately matching an opening of a bumper cover.

In particular, when the washer cover fixed to the head unit of the telescope linearly moves forward and backward, assembly tolerance, in which the edge of the washer cover does not accurately match the opening of the bumper cover, may occur and there may be difficulty in assembly tolerance control to remove such assembly tolerance.

Further, the rotatable open type washer cover requires various elements, such as an actuator to rotate the washer cover, a rotary bracket to form a rotating trajectory of the washer cover and a steel spring to absorb rotating impact, which may result in increased production costs and weight.

### SUMMARY

The present invention has an object of providing a device for covering a head lamp washer of a vehicle in which a protruding open-type washer cover mounted at a head unit of a telescope may move forward so as to be opened when the head lamp washer moves forward, absorb assembly tolerance, and accurately match an opening of a bumper cover.

In one aspect, the present invention provides a device for covering a head lamp washer of a vehicle, including a washer cover configured to open and close an opening formed on a bumper cover, a telescope having a head unit with a washer liquid jetting nozzle and disposed inside the bumper cover, a first coupling bracket configured to mount the washer cover thereon so as to be angularly rotatable, and a second coupling bracket fixed to the head unit of the telescope, wherein the first coupling bracket is coupled with the second coupling bracket such that the coupling length therebetween is adjustable. For example, the coupling length between the first and second coupling brackets may be adjustable using a sliding method.

In a preferred embodiment, the rear end of the washer cover may be coupled with the front end of the first coupling bracket so as to be angularly rotatable. For example, the rear end of the washer may be coupled with the front end of the first coupling bracket using a ball joint method.

In another preferred embodiment, a hinge protrusion may be formed at the rear end of the washer cover and a hinge hole to receive the hinge protrusion inserted thereinto so as to be angularly rotatable may be formed at the front end of the first coupling bracket.

In still another preferred embodiment, a coupling protrusion may be formed at the circumferential part of the hinge protrusion, and an anti-separation protrusion to restrain the coupling protrusion so as to prevent separation of the washer cover may be formed on the inner diameter part of the hinge hole.

In yet another preferred embodiment, a coupling hole to couple with the head unit of the telescope by press fitting may be formed at a rear part of the second coupling bracket.

In still yet another preferred embodiment, coupling legs having first saw-toothed grooves may be formed integrally with the rear end of the first coupling bracket, second saw-toothed grooves may be formed on the side surfaces of the second coupling bracket, and the coupling legs of the first coupling bracket may slide on the side surfaces of the second coupling bracket so that the first saw-toothed grooves are engaged with the second saw-toothed grooves.

In a further preferred embodiment, a coupling direction guide leg may be formed integrally with the lower end of the first coupling bracket and a coupling direction guide hole to couple with the coupling direction guide leg inserted thereinto may be formed at the lower end of the second coupling bracket.

In another further preferred embodiment, a cover bracket to guide the forward and backward movement direction of the washer cover and to support the washer cover so as to become coplanar with the skin surface of the bumper cover may be mounted on the rear surface of the bumper cover by ultrasonic fusion.

In still another further preferred embodiment, a telescope entrance having a smaller size than the opening of the bumper cover may be formed through the central portion of the cover bracket, and a support surface to support the washer cover so as to become coplanar with the skin surface of the bumper cover may be formed around the telescope entrance.

In yet another further preferred embodiment, guide tubes to receive guide bars, formed integrally with the rear surface of the washer cover, may be formed integrally with the support surface of the cover bracket.

Other aspects and preferred embodiments of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1 and 2 are exploded perspective views of a device for covering a head lamp washer of a vehicle in accordance with the present invention;

FIGS. 3 and 4 are assembled perspective views of the device for covering a head lamp washer of a vehicle in accordance with the present invention;

FIGS. 5 and 6 are cross-sectional views illustrating the operating state of the device for covering a head lamp washer of a vehicle in accordance with the present invention; and

FIGS. 7 and 8 are longitudinal-sectional views illustrating the operating state of the device for covering a head lamp washer of a vehicle in accordance with the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawings.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

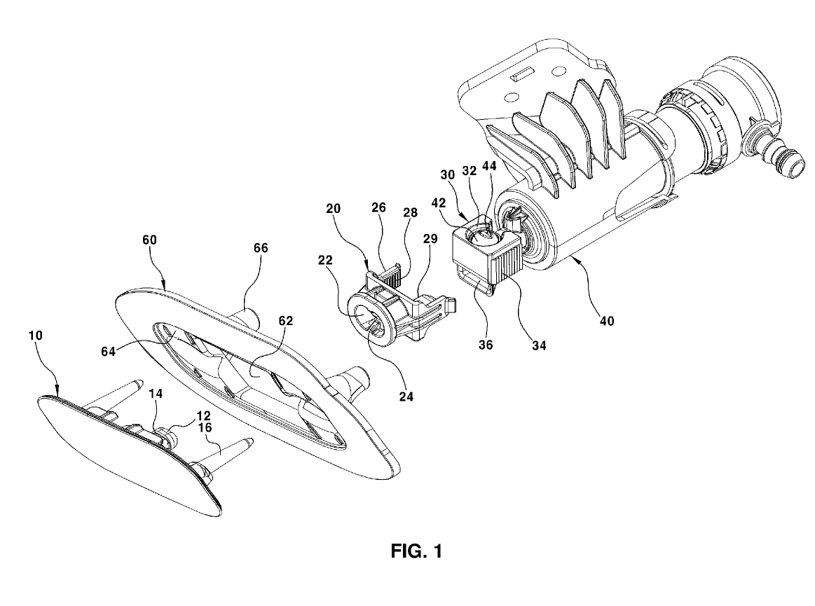

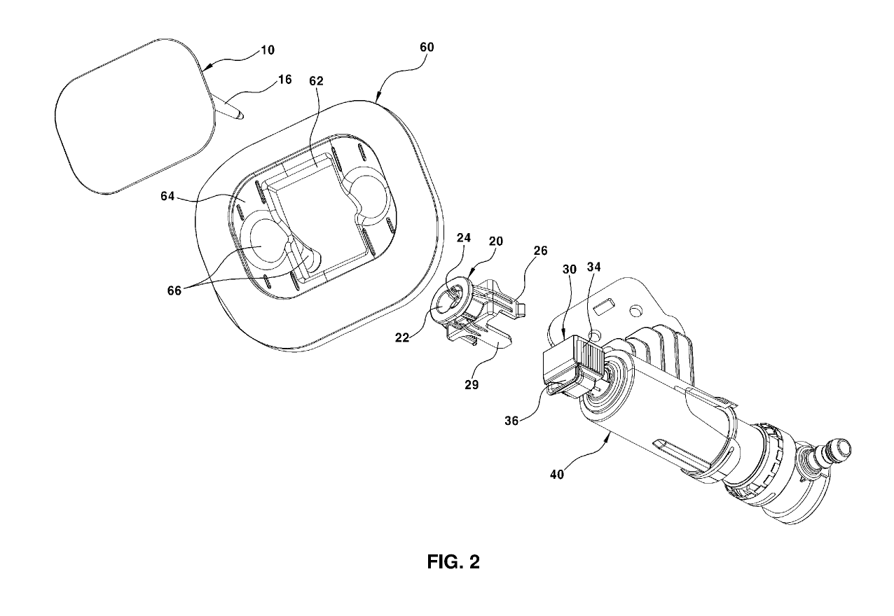

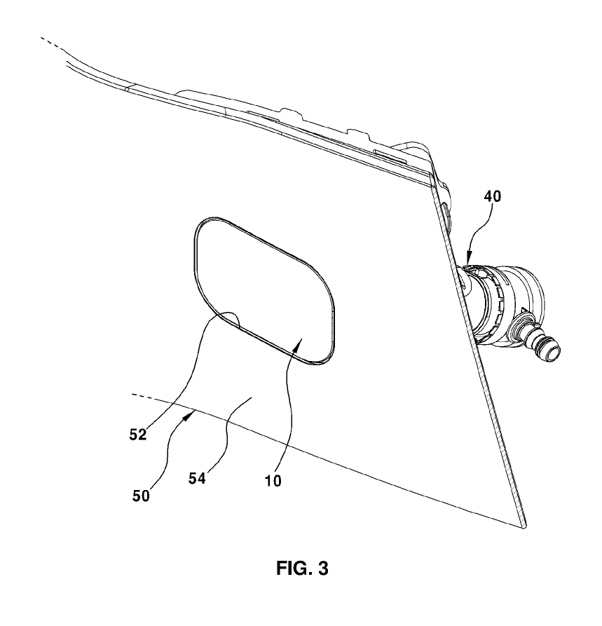

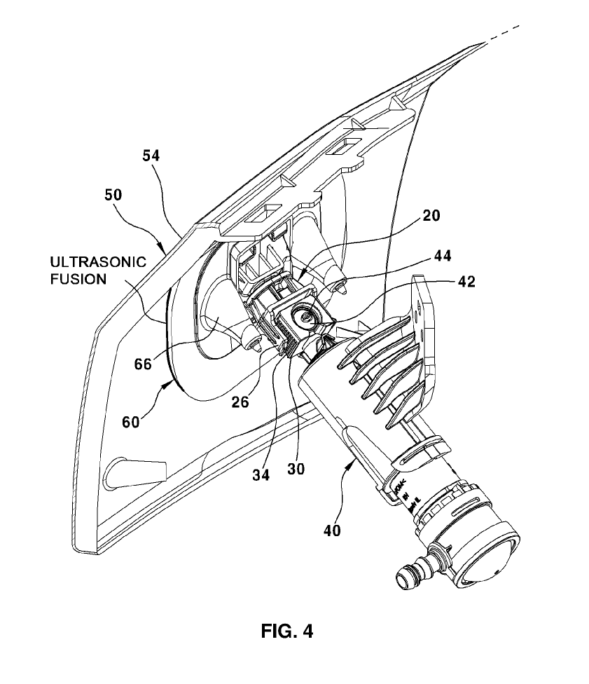

FIGS. 1 and 2 are exploded perspective views of a device for covering a head lamp washer of a vehicle in accordance with the present invention, and FIGS. 3 and 4 are assembled perspective views of the device for covering a head lamp washer of a vehicle in accordance with the present invention.

In FIGS. 1 to 4, reference numeral 10 indicates a washer cover, and reference numeral 20 indicates a first coupling bracket coupled with a rear surface of the washer cover 10.

The washer cover 10 serves to open and close an opening 52 (see, e.g., FIG. 3) formed on a bumper cover 50 (see, e.g., FIGS. 3 and 4) and the surface of the washer cover 10 preferably has the same shape as that of a skin surface 54 of the bumper cover 50.

The first coupling bracket 20 is connected to the rear surface of the washer cover 10 by a ball joint or a hinge, and thus the washer cover 10 may be angularly rotated in the upward, downward, leftward and rightward directions with respect to the first bracket 20.

Preferably, a ball joint hole is formed at a front end of the first coupling bracket 20, a ball is formed integrally with the rear end of the washer cover 10, and the ball is coupled with an inside of the ball joint hole so as to be angularly rotatable, thereby allowing the washer cover 10 to be ball-jointed with the first coupling bracket 20 so as to be angularly rotatable with respect to the first coupling bracket 20.

More preferably, a ball-shaped hinge protrusion 12 is formed integrally with the rear end of the washer cover 10, a hinge hole 22 is formed at the front end of the first coupling bracket 20, and the hinge protrusion 12 is inserted into the hinge hole 22 so as to be angularly rotatable, thereby allowing the washer cover 10 to be hinged to the first coupling bracket 20 so as to be angularly rotatable with respect to the first coupling bracket 20.

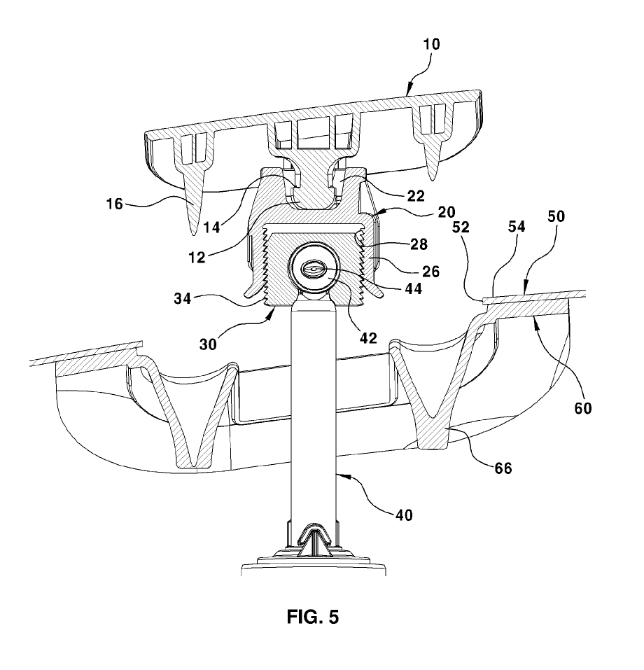

Referring to FIGS. 5 to 8, a coupling protrusion 14 is formed at a circumferential part of the hinge protrusion 12 formed at the rear end of the washer cover 10, and an anti-separation protrusion 24 to restrain the coupling protrusion 14 is formed integrally with the inside of the hinge hole 22 of the first coupling bracket 20.

Therefore, the hinge protrusion 12 of the washer cover 10 is inserted into the hinge hole 22 of the first coupling bracket 20 and, simultaneously, the coupling protrusion 14 is restrained by the anti-separation protrusion 24, thereby easily preventing the washer cover 10 from being separated from the first coupling bracket 20.

Further, a telescope 40 to jet a washer liquid is disposed inside the bumper cover 50 so as to be movable forward and backward.

The telescope 40 moves forward or backward by an electrical signal, as is well known, and a washer liquid jetting nozzle 44 to jet the washer liquid is formed at a head unit 42 of the telescope 40.

If jetting of the washer liquid is not required, the telescope 40 is located within the bumper cover 50 by backward movement, and if jetting of the washer liquid is required, the telescope 40 moves to an outside via the opening 52 of the bumper cover 50 by forward movement and the washer liquid jetting nozzle 42 of the telescope 40 moved to the outside jets the washer liquid to a head lamp.

As provided herein, a hexahedral block-shaped second coupling bracket 30 is fixed to the head unit 42 of the telescope 40.

In more detail, a coupling hole 32 is formed at a rear part of the second coupling bracket 30 and the head unit 42 of the telescope 40 is coupled with the inside of the coupling hole 32 by press fitting, thereby fixing the second coupling bracket 30 to the head unit 42 of the telescope 40.

The first coupling bracket 20 coupled with the washer cover 10 is slidably coupled with the second coupling bracket 30 coupled with the telescope 40 such that the coupling length therebetween is adjustable.

For this purpose, two or more coupling legs 26 having first saw-toothed grooves 28 protrude integrally from the rear end of the first coupling bracket 20 and second saw-toothed grooves 34 are formed on side surfaces of the second coupling bracket 30.

Further, a coupling direction guide leg 29 is formed integrally with a lower end of the first coupling bracket 20 and a coupling direction guide hole 36, into which the coupling direction guide leg 29 moves rectilinearly and is inserted, is formed at a lower end of the second coupling bracket 30.

Therefore, when a worker pushes the first coupling bracket 20 coupled with the washer cover 10 toward the second coupling bracket 30 on an in-line assembly line, the coupling direction guide leg 29 of the first coupling bracket 20 is inserted into the coupling direction guide hole 36 of the second coupling bracket 30, and thus may accurately guide the assembly direction of the first coupling bracket 20 coupled with the washer cover 10.

Simultaneously, the coupling legs 26 of the first coupling bracket 20 having elastically restoring force are stretched in the outward direction and slide along both side surfaces of the second coupling bracket 30.

During such sliding, the first saw-toothed grooves 28 of the coupling legs 26 and the second saw-toothed grooves 34 of the second coupling bracket 30 sequentially contact each other, and when the coupling legs 26 are stopped at a desired position during sliding, the first saw-toothed grooves 28 of the coupling legs 26 are engaged with the second saw-toothed grooves 34 of the second coupling bracket 30, thereby coupling the first and second coupling brackets 20 and 30 with each other.

Here, a point of time when the coupling legs 26 are stopped at the desired position becomes a point of time when the surface of the washer cover 10 is coplanar with the skin surface 54 of the bumper cover 50 (a point of time when the circumferential surface of the washer cover 10 accurately matches the inside of the opening 52 of the bumper cover 50).

In more detail, when a worker pushes the first coupling bracket 20 coupled with the washer cover 10 toward the second coupling bracket 30 on the in-line assembly line and then stops the pushing operation of the first coupling bracket 20 when the surface of the washer cover 10 is coplanar with the skin surface 54 of the bumper cover 50, the coupling legs 26 of the first coupling bracket 20 are stopped at a desired position, and thus the first saw-toothed grooves 28 of the coupling legs 26 are engaged with the second saw-toothed grooves 34 of the second coupling bracket 30, thereby achieving coupling between the first and second coupling brackets 20 and 30.

Since the worker may adjust the surface of the washer cover 10 so as to be coplanar with the skin surface 54 of the bumper cover 50 at all times on the in-line assembly line, as described above, assembly tolerance problems, such as a height difference between the bumper cover 50 and the washer cover 10, may be solved.

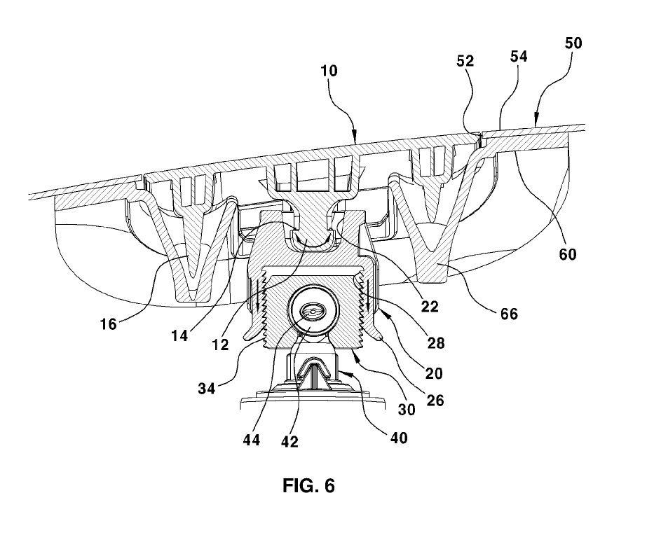

Further, with reference to FIGS. 5 and 6, a cover bracket 60, which guides the forward and backward movement direction of the washer cover 10 and supports the washer cover 10 so as to become coplanar with the skin surface 54 of the bumper cover 50, is joined to the rear surface of the bumper cover 50 by ultrasonic fusion.

A telescope entrance 62 having a smaller size than the opening 52 of the bumper cover 50 is formed through the central portion of the cover bracket 60, and a support surface 64, which supports the washer cover 10 so as to be coplanar with the skin surface 54 of the bumper cover 50, is formed around the telescope entrance 62.

Hollow-type guide tubes 66 extending backward are formed integrally with the support surface 64 of the cover bracket 60, and guide bars 16 protruding integrally from the rear surface of the washer cover 10 enter and exit the guide tubes 66 when the washer cover 10 moves forward and backward.

Therefore, since the guide bars 16 of the washer cover 10 enter and exit the guide tubes 66 of the cover bracket 60 when the washer cover 10 together with the telescope 40 moves forward and backward, the forward and backward movement direction of the washer cover 10 may be regularly maintained.

Further, when the washer cover 10 together with the telescope 40 moves forward and then moves backward, the rear surface of the washer cover 10 contacts and is supported by the support surface 64 of the cover bracket 60 at a point of time when the circumferential surface of the washer cover 10 is inserted into the opening 52 of the bumper cover 50 and accurately matches the inside of the opening 52. Therefore, coplanarity of the surface of the washer cover 10 with the skin surface 54 of the bumper cover 50 may be more assured.

Now, the operating process of the above-described device for covering a head lamp washer of a vehicle will be described as follows.

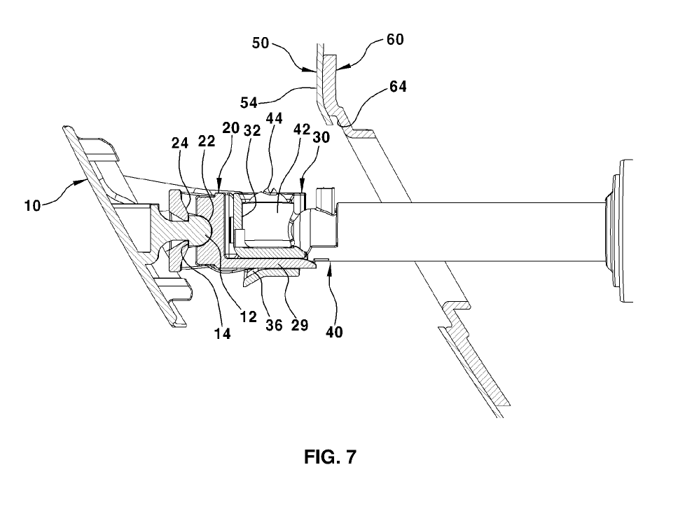

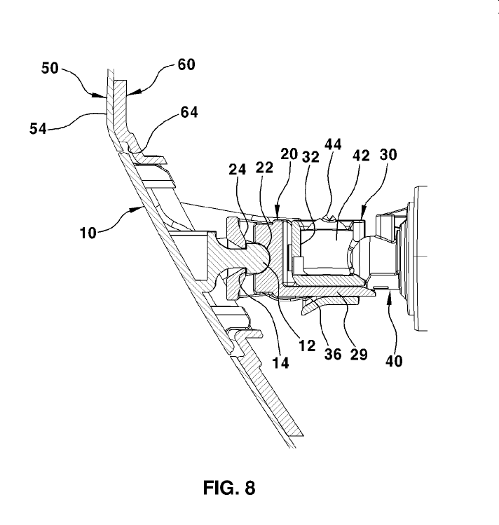

FIGS. 5 and 7 are sectional views illustrating the opened state of the device for covering a head lamp washer of a vehicle in accordance with the present invention, and FIGS. 6 and 8 are sectional views illustrating the closed state of the device for covering a head lamp washer of a vehicle in accordance with the present invention.

First, if jetting of a washer liquid to wipe away dust from a head lamp is required, the head unit 42 of the telescope 40 moves forward by forward movement of the telescope 40.

Simultaneously, the second coupling bracket 30 mounted at the head unit 42, the first coupling bracket 20 coupled with the second coupling bracket 30, and the washer cover 10 coupled with the first coupling bracket 20 move forward together.

Then, the opening 52 of the bumper cover 50 is opened by forward movement of the washer cover 10 and the head unit 42 of the telescope 40 moves to the outside of the bumper cover 50 through the opening 52.

Therefore, the washer liquid jetting nozzle 44 formed at the head unit 42 jets the washer liquid to the surface of the head lamp, thereby easily removing dust from the head lamp.

When the telescope 40 moves backward after jetting of the washer liquid toward the head lamp has been completed, the second coupling bracket 30 mounted at the head unit 42, the first coupling bracket 20 coupled with the second coupling bracket 30 and the washer cover 10 coupled with the first coupling bracket 20 move backward together.

Here, although the washer cover 10 misses the surface of the bumper cover 50 at an angle due to external force prior to backward movement, i.e., although the washer cover 10 misses the hinge coupling point with the first coupling bracket 20 at an angle, the washer cover 10 may accurately matches the inside of the opening 52 of the bumper cover 50 and be inserted into the opening 52 of the bumper cover 50.

First, when the washer cover 10 moves forward together with the telescope 40 and then moves backward, the guide bars 16 of the washer cover 10 are inserted into the guide tubes 66 of the cover bracket 60, and thus the backward movement direction is assured. Therefore, the washer cover 10 accurately fits with the opening 52 of the bumper cover 50.

Thereafter, when the washer cover 10 continues to move backward and the rear surface of the washer cover 10 contacts and is supported by the support surface 64 of the cover bracket 60, one side of the rear surface of the washer cover 10 first contacts the support surface 64 because the washer cover 10 is misplaced at an angle.

Thereafter, the other side of the rear surface of the washer cover 10 is angularly rotated about the hinge coupling point with the first coupling bracket 20 (the point where the hinge protrusion 12 is coupled with the inside of the hinge hole 22) by the pulling force of the telescope 40, and thus the entirety of the rear surface of the washer cover 10 contacts and is supported by the support surface 64 of the cover bracket 60.

Therefore, although the washer cover 10 misses the surface of the bumper cover 50 atan angle by external force prior to backward movement, an accurate fit between the washer cover 10 and the opening 52 of the bumper cover 50 is assured and the entirety of the rear surface of the washer cover 10 contacts and is supported by the support surface 64 of the cover bracket 60. Accordingly, the circumferential surface of the washer cover 10 accurately matches and is inserted into the opening 52 of the bumper cover 50 and the surface of the washer cover 10 becomes coplanar with the skin surface 54 of the bumper cover 50.

As described above, by connecting the washer cover 10 to the head unit 42 of the telescope 40 via the first and second coupling brackets 20 and 30 so as to be angularly rotatable, although the bumper cover 50 is inclined or curved, tolerance of the washer cover 10 with respect to the opening 52 of the bumper cover 50 in the upward, downward, leftward and rightward directions may be absorbed, the washer cover 10 may be inserted into the opening 52 of the bumper cover 50 so as to accurately match the inside of the opening 52, and the surface of the washer cover 10 and the skin surface 52 of the bumper cover 50 may be coplanar whenever the washer cover 10 is closed, thereby enhancing aesthetics of the external appearance of the washer cover 10.

As is apparent from the above description, the present invention provides the following effects.

First, by connecting a washer cover to a head unit of a telescope using first and second coupling brackets so as to be angularly rotatable, even if a bumper cover is inclined or curved, the washer cover may be angularly rotated in the upward, downward, leftward and rightward directions and thus absorb tolerance with an opening of the bumper cover in the upward, downward, leftward and rightward directions.

Second, the first coupling bracket coupled with the washer cover so as to be angularly rotatable may be coupled with the second coupling bracket mounted at the head unit of the telescope such that the coupling length therebetween is adjustable using saw-toothed structures, thereby easily absorbing tolerance in the length direction during an in-line assembly process.

Third, by removing tolerance of the washer cover with the opening of the bumper cover in the upward, downward, leftward and rightward directions and tolerance of the washer cover in the length direction, the surface of the washer cover may be coplanar with the skin surface of the bumper cover when the washer cover is closed, thereby enhancing aesthetics of the external appearance of the washer cover.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A device for covering a head lamp washer of a vehicle, comprising:
a washer cover configured to open and close an opening formed on a bumper cover;
a telescope having a head unit with a washer liquid jetting nozzle and disposed inside the bumper cover;
a first coupling bracket configured to mount the washer cover thereon so as to be angularly rotatable; and
a second coupling bracket fixed to the head unit of the telescope,
wherein the first coupling bracket is coupled with the second coupling bracket such that the coupling length therebetween is adjustable.

2. The device of claim 1, wherein a rear end of the washer cover is coupled with a front end of the first coupling bracket so as to be angularly rotatable.

3. The device of claim 1, wherein a hinge protrusion is formed at a rear end of the washer cover, and a hinge hole to receive the hinge protrusion inserted thereinto so as to be angularly rotatable is formed at a front end of the first coupling bracket.

4. The device of claim 3, wherein a coupling protrusion is formed at a circumferential part of the hinge protrusion, and an anti-separation protrusion to restrain the coupling protrusion so as to prevent separation of the washer cover is formed on an inner diameter part of the hinge hole.

5. The device of claim 1, wherein a coupling hole to couple with the head unit of the telescope by press fitting is formed at a rear part of the second coupling bracket.

6. The device of claim 1, wherein coupling legs having first saw-toothed grooves are formed integrally with a rear end of the first coupling bracket, second saw-toothed grooves are formed on side surfaces of the second coupling bracket, and the coupling legs of the first coupling bracket slide on the side surfaces of the second coupling bracket so that the first saw-toothed grooves are engaged with the second saw-toothed grooves.

7. The device of claim 1, wherein a coupling direction guide leg is formed integrally with a lower end of the first coupling bracket, and a coupling direction guide hole to couple with the coupling direction guide leg inserted thereinto is formed at a lower end of the second coupling bracket.

8. The device of claim 1, wherein a cover bracket to guide the forward and backward movement direction of the washer cover and to support the washer cover so as to become coplanar with the skin surface of the bumper cover is mounted on a rear surface of the bumper cover by ultrasonic fusion.

9. The device of claim 8, wherein a telescope entrance having a smaller size than the opening of the bumper cover is formed through the central portion of the cover bracket, and a support surface to support the washer cover so as to become coplanar with the skin surface of the bumper cover is formed around the telescope entrance.

10. The device of claim 9, wherein guide tubes to receive guide bars, formed integrally with a rear surface of the washer cover, are formed integrally with the support surface of the cover bracket.
